(19) United States
(12) Patent Application Publication
(10) Pub. No.: US 2008/0184010 A1
(43) Pub. Date: Jul. 31, 2008

(54) METHOD AND APPARATUS FOR CONTROLLING INSTRUCTION CACHE PREFETCH

(75) Inventor: Masato Uchiyama, Kawasaki-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/967,671

(22) Filed: Dec. 31, 2007

(30) Foreign Application Priority Data
Jan. 30, 2007 (JP) 2007-019083

(51) Int. Cl. G06F 9/312

(52) U.S. Cl. 712/207; 712/E09.033

(57) ABSTRACT

According to the present invention, there is provided an instruction cache prefetch control apparatus having an external memory, a CPU and an instruction cache unit, the instruction cache unit having: an instruction cache data memory which receives and stores the instruction sequence; a prefetch buffer which prefetches and stores an instruction sequence next to the instruction sequence as a target of a fetch request from the CPU when the next instruction sequence is not stored in the instruction cache data memory; an instruction cache write control unit which selectively outputs, to the instruction cache data memory, one of the instruction sequence output from the external memory and the instruction sequence stored in the prefetch buffer; and a hit or miss determination access control unit which, upon receiving, from the CPU, a fetch request for the instruction sequence stored in the prefetch buffer, transfers the instruction sequence from the prefetch buffer to the instruction cache data memory and stores the instruction sequence in the instruction cache data memory, and if branch has occurred before the CPU executes the instruction sequence stored in the prefetch buffer, determines and controls in accordance with a type of the branch whether to transfer the instruction sequence from the prefetch buffer to the instruction cache data memory and store the instruction sequence in the instruction cache data memory.

### CROSS REFERENCE TO RELATED APPLICATION

This application is based upon and claims benefit of priority under 35 USC §119 from the Japanese Patent Application No. 2007-19083, filed on Jan. 30, 2007, the entire contents of which are incorporated herein by reference.

### BACKGROUND OF THE INVENTION

The present invention relates to an instruction cache prefetch control method and apparatus.

An apparatus for executing a program using an instruction cache data memory includes a prefetch mechanism. If an instruction sequence next to a currently executed instruction sequence does not exist in an instruction cache data memory, the prefetch mechanism prefetches the instruction sequence in a dedicated prefetch buffer and transfers the instruction sequence from the prefetch buffer to the instruction cache data memory. This mechanism is described in reference 1 to be described later.

In broad terms, the following two control methods are available to write, in the instruction cache data memory, the instruction sequence prefetched in the prefetch buffer.

(A) After confirming that a prefetched instruction sequence will be executed, it is transferred to the instruction cache data memory. If it is necessary to prefetch another instruction sequence, prefetch is done by overwriting the instruction sequence. This method is disclosed in reference 2 to be described later.

(B) A prefetched instruction sequence is always transferred to and stored in the instruction cache data memory independently of whether the central processing unit (to be referred to as a CPU hereinafter) will execute it.

In the method (A), if the prefetched instruction sequence is discarded before use, a need for prefetching the same instruction sequence again can arise. When such control is repeated, the traffic of the external bus increases due to wasteful prefetch, resulting in lower efficiency.

On the other hand, in the method (B), the instruction cache data memory can store an instruction sequence that is actually unnecessary. In this case, another necessary instruction sequence already stored in the instruction cache data memory is pushed out, and consequently, the efficiency lowers.

Reference 1: fall-through prefetch method in Wei-Chung-Hsu, “A Performance Study of Instruction Sequence Prefetching Methods”, IEEE Transaction on COMPUTERS Vol. 47, No. 5, pp. 497-508

Reference 2: Japanese Patent Laid-Open No. 2003-162446

### SUMMARY OF THE INVENTION

According to one aspect of the present invention, there is provided an instruction cache prefetch control apparatus comprising: an external memory which receives and stores an instruction sequence; a central processing unit (to be referred to as a CPU hereinafter) which receives and executes the instruction sequence; and an instruction cache unit which reads out, from said external memory, the instruction sequence to be executed by said CPU, stores the instruction sequence, and supplies the instruction sequence to said CPU, said instruction cache unit comprising: an instruction cache data memory which receives and stores the instruction sequence; a prefetch buffer which prefetches and stores an instruction sequence next to the instruction sequence as a target of a fetch request from said CPU when the next instruction sequence is not stored in said instruction cache data memory; an instruction cache write control unit which selectively outputs, to said instruction cache data memory, one of the instruction sequence output from said external memory and the instruction sequence stored in said prefetch buffer; and a hit or miss determination access control unit which, upon receiving, from said CPU, a fetch request for the instruction sequence stored in said prefetch buffer, transfers the instruction sequence from said prefetch buffer to said instruction cache data memory and stores the instruction sequence in the instruction cache data memory, and if branch has occurred before said CPU executes the instruction sequence stored in said prefetch buffer, determines and controls in accordance with a type of the branch whether to transfer the instruction sequence from said prefetch buffer to said instruction cache data memory and store the instruction sequence in the instruction cache data memory.

According to one aspect of the present invention, there is provided an instruction cache prefetch control apparatus comprising: an external memory which receives and stores an instruction sequence; a CPU which receives and executes the instruction sequence; and an instruction cache unit which reads out, from said external memory, the instruction sequence to be executed by said CPU, stores the instruction sequence, and supplies the instruction sequence to said CPU, said instruction cache unit comprising: an instruction cache data memory which receives and stores the instruction sequence; a prefetch buffer which prefetches and stores an instruction sequence next to the instruction sequence as a target of a fetch request from said CPU when the next instruction sequence is not stored in said instruction cache data memory; an instruction cache write control unit which selectively outputs, to said instruction cache data memory, one of the instruction sequence output from said external memory and the instruction sequence stored in said prefetch buffer; and a hit or miss determination access control unit which, upon receiving a fetch request for a first instruction sequence from said CPU and determining that the first instruction sequence does not exist in said instruction cache data memory, reads out the first instruction sequence from said external memory and stores the first instruction sequence in said instruction cache data memory, upon determining that a second instruction sequence next to the first instruction sequence is stored in neither said instruction cache data memory nor said prefetch buffer, reads out the second instruction sequence from said external memory and stores the second instruction sequence in said prefetch buffer, and if branch has occurred before said CPU executes a third instruction sequence stored in said prefetch buffer, determines and controls in accordance with a type of the branch whether to transfer the third instruction sequence from said prefetch buffer to said instruction cache data memory and store the third instruction sequence in the instruction cache data memory.

According to one aspect of the present invention, there is provided a control method of an instruction cache prefetch control apparatus including an external memory which receives and stores an instruction sequence, a CPU which receives and executes the instruction sequence, and an instruction cache unit which reads out, from the external memory, the instruction sequence to be executed by the CPU, stores the instruction sequence, and supplies the instruction sequence to the CPU, comprising causing the instruction cache unit to when a fetch request for a first instruction sequence is issued from the CPU, and a hit or miss determination access control unit determines that the first instruction sequence does not exist in an instruction cache data memory, read out the first instruction sequence from the external memory and store the first instruction sequence in the instruction cache data memory, when the hit or miss determination access control unit determines that a second instruction sequence next to the first instruction sequence is stored in neither the instruction cache data memory nor a prefetch buffer, read out the second instruction sequence from the external memory and store the second instruction sequence in the prefetch buffer, and if branch has occurred before the CPU executes a third instruction sequence stored in the prefetch buffer, cause the hit or miss determination access control unit to determine and control in accordance with a type of the branch whether to transfer the third instruction sequence from the prefetch buffer to the instruction cache data memory and store the third instruction sequence in the instruction cache data memory.

### BRIEF DESCRIPTION OF THE DRAWINGS

FIG. 1 is a block diagram showing the arrangement of an instruction cache prefetch control apparatus according to reference example 1;

FIG. 2 is a flowchart illustrating a process procedure according to reference example 1;

FIG. 3 is a flowchart illustrating a process procedure of an instruction cache prefetch control apparatus according to reference example 2;

FIG. 4 is a block diagram showing the arrangement of an instruction cache prefetch control apparatus according to an embodiment of the present invention; and

FIG. 5 is a flowchart illustrating a process procedure according to the embodiment.

### DETAILED DESCRIPTION OF THE INVENTION

### REFERENCE EXAMPLE 1

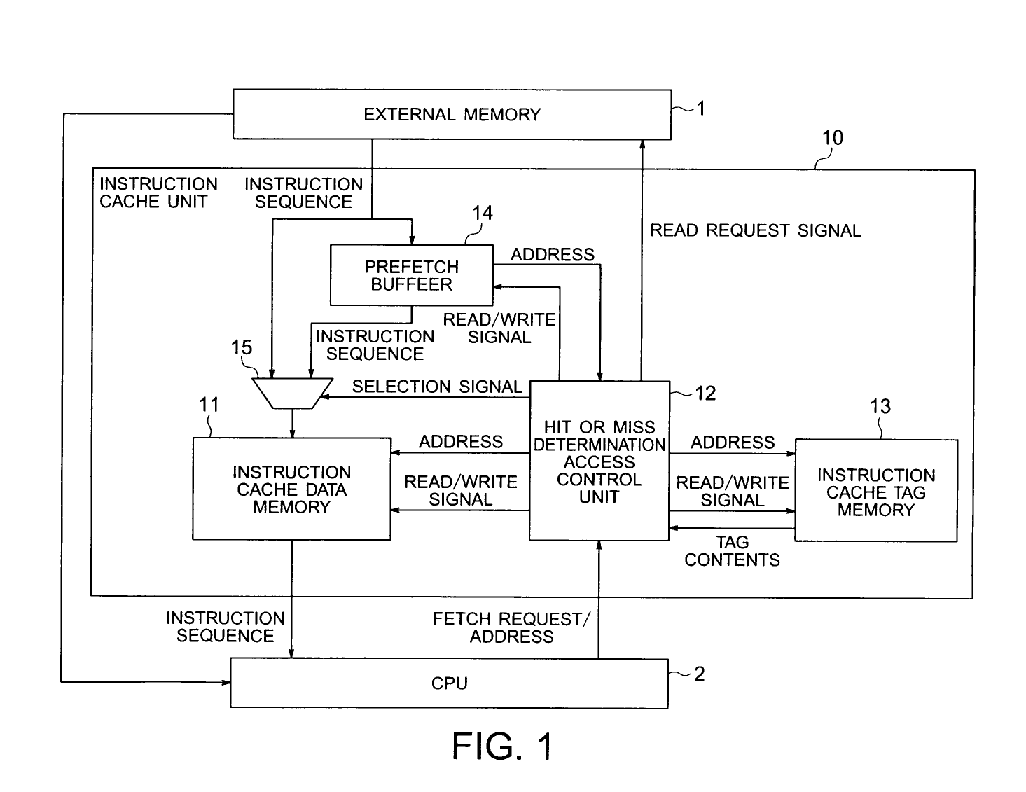

The arrangement of an instruction cache prefetch control apparatus which executes prefetch control based on the method (A) will be described first with reference to FIG. 1 as reference example 1.

This apparatus includes an external memory 1 which stores an instruction sequence, a CPU 2 which executes an instruction sequence, and an instruction cache unit 10 which caches an instruction sequence. The instruction cache unit 10 includes an instruction cache data memory 11, hit or miss determination access control unit 12, instruction cache tag memory 13, prefetch buffer 14, and instruction cache write control unit 15.

The prefetch buffer 14 prefetches an instruction sequence supplied from the external memory 1. The prefetch buffer 14 has a capacity to store an instruction sequence of one unit.

The instruction cache write control unit 15 receives a selection signal from the hit or miss determination access control unit 12 and selectively outputs an instruction sequence output from the prefetch buffer 14 or external memory 1.

The instruction cache data memory 11 receives and stores the instruction sequence output from the instruction cache write control unit 15. The stored instruction sequence is supplied to the CPU 2 and executed.

The instruction cache tag memory 13 stores tag contents representing information for judging whether an instruction sequence corresponding to an address as the target of a fetch request issued from the CPU 2 exists in the instruction cache data memory 11.

The hit or miss determination access control unit 12 determines whether the instruction sequence as the target of the fetch request from the CPU 2 exists in the instruction cache data memory 11, i.e., hit or miss. More specifically, the hit or miss determination access control unit 12 supplies a read signal and the address corresponding to the fetch request to the instruction cache tag memory 13 and reads out a tag contents signal. If the tag contents represent that the instruction cache data memory 11 stores the corresponding instruction sequence (hit), the hit or miss determination access control unit 12 supplies the address and read signal to the instruction cache data memory 11 so that the instruction sequence is read out and supplied to the CPU 2. The prefetch buffer 14 supplies an address signal, i.e., the address of the prefetched instruction sequence to the hit or miss determination access control unit 12.

A process procedure according to reference example 1 will be explained below.

1) The CPU 2 sends the fetch request and address of the first instruction sequence to the hit or miss determination access control unit 12.

2) The hit or miss determination access control unit 12 transfers the address and read signal to the instruction cache tag memory 13. The instruction cache tag memory 13 reads out tag contents corresponding to the address and outputs them to the hit or miss determination access control unit 12.

3) The hit or miss determination access control unit 12 determines on the basis of the tag contents whether the instruction sequence as the target of the fetch request from the CPU 2 exists in the instruction cache data memory 11, i.e., hit or miss.

In case of a hit, the hit or miss determination access control unit 12 transfers the address and read signal to the instruction cache data memory 11 so that the first instruction sequence corresponding to the address is read out and output to the CPU 2. In case of a miss, the first instruction sequence is nonexistent normally. In this case, the hit or miss determination access control unit 12 refers to an address output from the prefetch buffer 14 and determines whether the first instruction sequence that is already prefetched exists.

4) If the prefetched instruction sequence exists, the first instruction sequence output from the prefetch buffer 14 is supplied to the instruction cache write control unit 15. The instruction cache write control unit 15 selectively supplies the instruction sequence to the instruction cache data memory 11 on the basis of the selection signal output from the hit or miss determination access control unit 12. The hit or miss determination access control unit 12 supplies an address and write signal to the instruction cache data memory 11 so that the instruction sequence is written in the instruction cache data memory 11.

If the first instruction sequence is not prefetched, normally the first instruction sequence is not prefetched. The hit or miss determination access control unit 12 outputs a read request signal to the external memory 1. Then, the readout first instruction sequence is supplied to the instruction cache data memory 11 through the instruction cache write control unit 15. The hit or miss determination access control unit 12 supplies an address and write signal to the instruction cache data memory 11 so that the instruction sequence is written in the instruction cache data memory 11 and then read out to the CPU 2.

5) Every time an instruction sequence is written in the instruction cache data memory 11, the hit or miss determination access control unit 12 supplies an address and write signal to the instruction cache tag memory 13 to update the tag contents.

6) Additionally, the hit or miss determination access control unit 12 starts the prefetch operation of the second instruction sequence upon receiving the fetch request for the first instruction sequence from the CPU 2. The hit or miss determination access control unit 12 refers to an address output from the prefetch buffer 14 and determines whether the second instruction sequence is already prefetched. If the second instruction sequence is not prefetched, the hit or miss determination access control unit 12 outputs a read request signal to the external memory 1.

7) The second instruction sequence read out from the external memory 1 is supplied to and written in the prefetch buffer 14 in accordance with a write signal output from the hit or miss determination access control unit 12.

The process is executed in accordance with the above procedure while the CPU 2 is sequentially executing instruction sequences. A case wherein branch occurs will be described next.

8) For example, assume that the first instruction sequence is executed by the CPU 2, the second instruction sequence is prefetched and stored in the prefetch buffer 14 but not in the instruction cache data memory 11, and in this state, the CPU 2 issues a fetch request for the 10th instruction sequence. In such a case, in reference example 1, the second instruction sequence is not executed and is not therefore written in the instruction cache data memory 11. First, the CPU 2 outputs an address and the fetch request for the 10th instruction sequence to the hit or miss determination access control unit 12.

9) The hit or miss determination access control unit 12 determines a hit or miss on the basis of tag contents read out from the instruction cache tag memory 13. In case of a hit, the instruction sequence is read out from the instruction cache data memory 11 and supplied to the CPU 2, as described above. In case of a miss, the instruction sequence is read out from the external memory 1, written in the instruction cache data memory 11, and then, read out and supplied to the CPU 2.

10) Additionally, the hit or miss determination access control unit 12 starts the prefetch operation of the 11th instruction sequence. The prefetch buffer 14 stores the second instruction sequence but not the 11th instruction sequence. The 11th instruction sequence is read out from the external memory 1 and written in the prefetch buffer 14. At this time, the second instruction sequence in stored in the prefetch buffer 14 is overwritten and destroyed without being transferred to the instruction cache data memory 11.

11) To execute the prefetched 11th instruction sequence, it is transferred to and written in the instruction cache data memory 11. If the 11th instruction sequence is not executed, an instruction sequence next to an instruction sequence as the target of the fetch request from the CPU 2 is overwritten in the prefetch buffer 14.

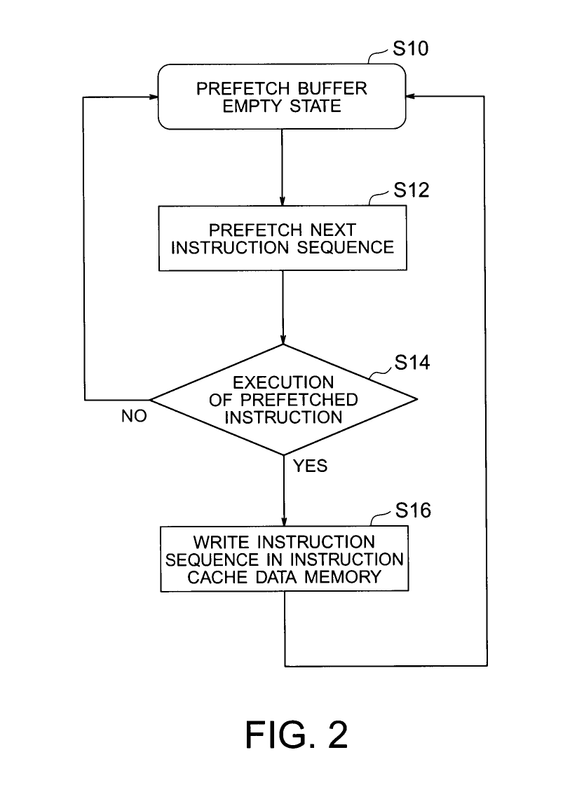

A process of writing an instruction sequence prefetched in the prefetch buffer 14 in the instruction cache data memory 11 will be described with reference to the flowchart in FIG. 2.

In step S10, the prefetch buffer 14 is empty or stores a destructible instruction sequence.

In step S12, the hit or miss determination access control unit 12 outputs a read request signal to the external memory 1 to prefetch the target of a fetch request from the CPU 2 and, for example, the second instruction sequence next to the first instruction sequence. The readout second instruction sequence is supplied to the prefetch buffer 14. The hit or miss determination access control unit 12 supplies a write signal to the prefetch buffer 14 so that the second instruction sequence is written in it.

In step S14, the hit or miss determination access control unit 12 determines whether to execute the prefetched second instruction sequence. When a request to fetch the second instruction sequence is received from the CPU 2, the instruction sequence is supplied to and stored in the instruction cache data memory 11 in step S16.

If the CPU 2 requests to fetch, e.g., the 10th instruction sequence of the branch destination without executing the second instruction sequence, the second instruction sequence is not supplied to the instruction cache data memory 11. The hit or miss determination access control unit 12 reads out the next 11th instruction sequence from the external memory 1. The 11th instruction sequence is supplied to and stored in the prefetch buffer 14.

As described above, in reference example 1, only when it is confirmed that the prefetched instruction sequence will be executed, the instruction sequence is stored in the instruction cache data memory 11. If the instruction sequence will not be executed, the instruction sequence of the branch destination as the target of the fetch request from the CPU 2 is fetched, and the next instruction sequence is prefetched and overwritten in the prefetch buffer 14. The instruction sequence that is prefetched but not executed is thus destroyed.

### REFERENCE EXAMPLE 2

The arrangement of an instruction cache prefetch control apparatus which executes prefetch control based on the method (B) will be described as reference example 2.

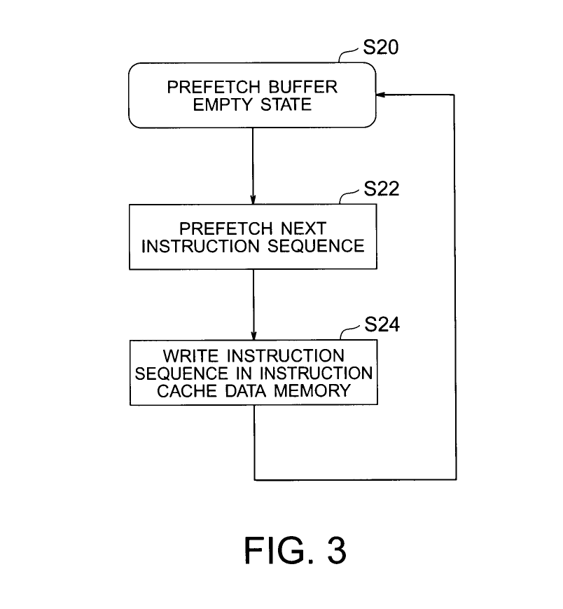

This apparatus has the same circuit arrangement as in reference example 1 shown in FIG. 1 except the control operation associated with prefetch by the hit or miss determination access control unit 12. A process procedure according to reference example 2 will be described with reference to the flowchart in FIG. 3.

In step S20, the prefetch buffer 14 is empty or stores a destructible instruction sequence.

In step S22, the hit or miss determination access control unit 12 outputs a read request signal to the external memory 1 to prefetch the target of a fetch request from the CPU 2 and, for example, the second instruction sequence next to the first instruction sequence. The readout second instruction sequence is supplied to the prefetch buffer 14. The hit or miss determination access control unit 12 supplies a write signal to the prefetch buffer 14 so that the second instruction sequence is written in it.

In step S24, the hit or miss determination access control unit 12 supplies the instruction sequence to the instruction cache data memory 11 independently of the presence/absence of execution of the prefetched second instruction sequence so that the instruction cache data memory 11 stores it.

Hence, even when the CPU 2 is to execute not the second instruction sequence already stored in the prefetch buffer 14 but the 10th instruction sequence, the second instruction sequence is transferred to and stored in the instruction cache data memory 11.

The second instruction sequence stored in the instruction cache data memory 11 can be destroyed when the next instruction sequence is prefetched. The process returns to step S20.

As described above, in reference example 2, a prefetched instruction sequence is always transferred from the prefetch buffer 14 and stored in the instruction cache data memory 11 independently of whether to execute the instruction sequence. After that, the instruction sequence is stored in the prefetch buffer 14.

### Embodiment

An instruction cache prefetch control method and apparatus according to an embodiment of the present invention will be described.

While instruction sequences have no branch and are always continuously being executed sequentially, prefetched instruction sequences are executed in order.

In the process of reference example 1 based on the method (A), a prefetched instruction sequence that will not be executed is discarded without being stored in the instruction cache data memory. When a need for executing that instruction sequence arises later, it must be prefetched again. In the process of reference example 2 based on the method (B), even an unnecessary instruction sequence that will never be executed is stored in the instruction cache data memory. Both these phenomena occur due to branch during execution of continuous instruction sequences.

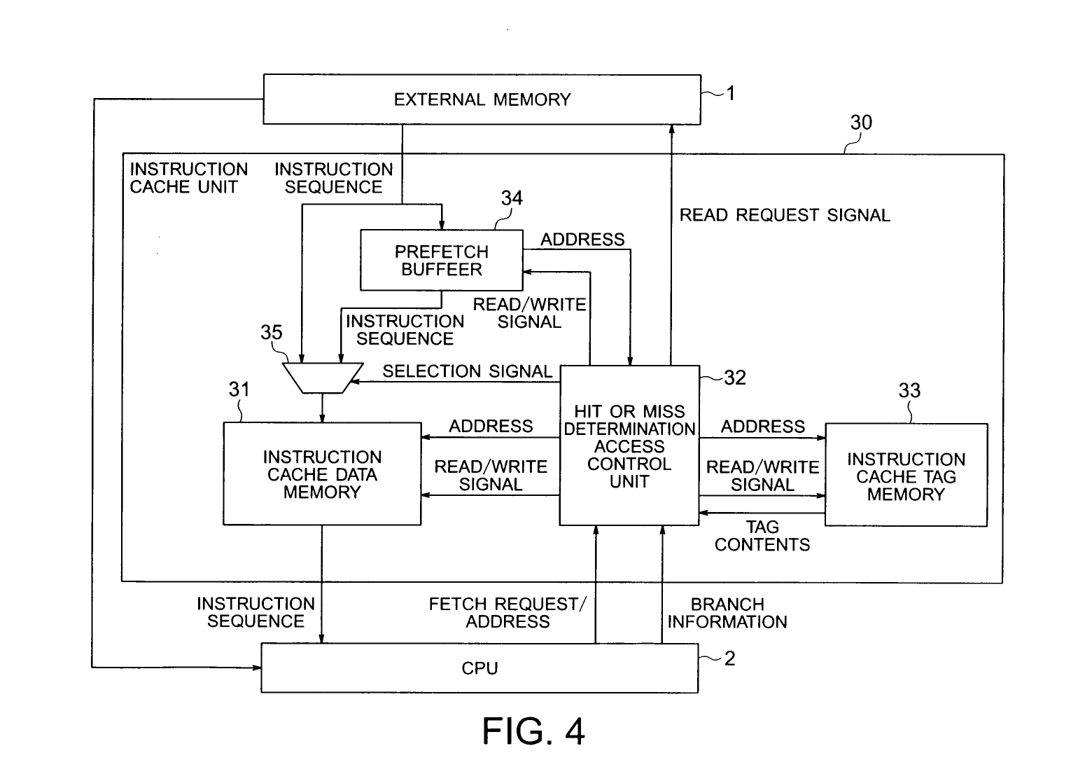

To the contrary, in the embodiment shown in FIG. 4, if branch occurs during execution of an instruction sequence, and a prefetch buffer 34 has already prefetched the next instruction sequence, whether to store this instruction sequence in an instruction cache data memory 31 is determined on the basis of the type of branch.

There are the following kinds of branch.

(1) Like “if ( . . . ) else ( . . . )” in the C language, if a predetermined condition is satisfied, forward branch occurs while skipping the succeeding instruction sequence. If the condition is not satisfied, the succeeding instruction sequence is executed without branch. However, whether to execute the instruction sequence following the branch source after the forward branch based on the satisfied condition is indeterminate. Normally, the succeeding instruction sequence is not executed.

(2) Like “for ( . . . ) { . . . }” or “while ( . . . ) {. . . }” in the C language, backward branch occurs to form a loop. The number of times of loop is not always designated. After the end of loop, an instruction sequence following that included in the loop process is executed at a high probability.

(3) Branch to a specific instruction sequence occurs due to subroutine call by function call. After the branch, the instruction sequence of the branch destination is executed. Then, the process returns to the branch source in many cases, and an instruction sequence following that of the branch source is executed at a high probability.

(4) Like “Jump” by exception, a signal is suddenly input from the outside of the processor, and an interrupt process based on the signal must be executed temporarily. After the end of the interrupt process, the succeeding instruction sequence is executed at a high probability.

(5) After a specific program such as a subroutine or a specific program sequence based on exception such as an exceptional vector is executed, the process returns. In this case, whether to execute the instruction sequence following the instruction sequence to which the process returns from the subroutine or exceptional vector is indeterminate.

(6) “Jump” to an external memory 1 outside the instruction cache data memory 31 occurs. In this case, whether to execute the instruction sequence following that of the branch destination in the external memory 1 is indeterminate. Normally, the succeeding instruction sequence is not executed. Whether to return to the instruction sequence following that of the branch source in the instruction cache data memory 31 and execute the instruction sequence is also indeterminate.

As described above, whether to execute the instruction sequence following that of the branch source or branch destination is predictable to some extent in accordance with the type of branch. Of (1) to (6) described above, the probability that the instruction sequence following that of the branch source or branch destination will be executed is low in (1), (5), and (6). The probability of execution is high in (2) to (4).

In this embodiment, this predictability is used. That is, when the instruction sequence following that of the branch source or branch destination is prefetched, whether to write it in the instruction cache data memory 31 is determined and controlled using the predictability.

More specifically, when branch of one of (2) to (4) has occurred, the instruction sequence prefetched in the prefetch buffer 34 is transferred to and written in the instruction cache data memory 31. When branch of (1), (5), or (6) has occurred, the instruction sequence is not transferred to and written in the instruction cache data memory 31.

If the prefetched instruction sequence is not transferred to the instruction cache data memory 31, the non-executable instruction sequence in the prefetch buffer 34 is discarded at a timing to prefetch a new executable instruction sequence, and overwritten by the newly prefetched instruction sequence.

FIG. 4 shows the arrangement of an instruction cache prefetch control apparatus according to the embodiment which executes the above-described control.

This apparatus includes the external memory 1 which stores an instruction sequence, a CPU 2 which executes an instruction sequence, and an instruction cache unit 30 which caches an instruction sequence. The instruction cache unit 30 includes the instruction cache data memory 31, hit or miss determination access control unit 32, instruction cache tag memory 33, prefetch buffer 34, and instruction cache write control unit 35.

The hit or miss determination access control unit 32 receives branch information from the CPU 2, in addition to a fetch request and address, unlike the hit or miss determination access control unit 12 of reference example 1. It is determined on the basis of the branch information whether to store, in the instruction cache data memory 31, an instruction sequence stored in the prefetch buffer 34.

The operation of the instruction cache prefetch control apparatus according to this embodiment will be described next.

While the CPU 2 is executing instruction sequences sequentially, the same process as in 1) to 8) described in reference example 1 is executed. A case wherein branch has occurred will be described next.

9) For example, assume that the first instruction sequence is executed by the CPU 2, the second instruction sequence is prefetched and stored in the prefetch buffer 34 but not in the instruction cache data memory 31, and in this state, the CPU 2 outputs an address and a fetch request for the 10th instruction sequence to the hit or miss determination access control unit 32.

10) The hit or miss determination access control unit 32 determines a hit or miss on the basis of tag contents read out from the instruction cache tag memory 33. In case of a hit, the instruction sequence is read out from the instruction cache data memory 31 and supplied to the CPU 2, as described above. In case of a miss, the instruction sequence is read out from the external memory 1, written in the instruction cache data memory 31, and then, read out and supplied to the CPU 2.

11) Additionally, the hit or miss determination access control unit 32 starts the prefetch operation of the 11th instruction sequence. The prefetch buffer 34 stores the second instruction sequence but not the 11th instruction sequence. The 11th instruction sequence is read out from the external memory 1 and written in the prefetch buffer 34.

In this case, in reference example 1, the second instruction sequence which will not be executed is not written in the instruction cache data memory 11. In reference example 2, the second instruction sequence is always transferred to and written in the instruction cache data memory 11, although it will not be executed.

In this embodiment, however, the hit or miss determination access control unit 32 determines on the basis of the branch information output from the CPU 2 whether to store the second instruction sequence in the instruction cache data memory 31.

Of (1) to (6) described above, the probability that the instruction sequence following that of the branch source or branch destination will be executed is low in (1), (5), and (6), as described above. The probability of execution is high in (2) to (4). If the hit or miss determination access control unit 32 determines on the basis of the branch information that the type of branch is one of (2) to (4), the second instruction sequence stored in the prefetch buffer 34 is transferred to and stored in the instruction cache data memory 31. After that, the 11th instruction sequence is read out from the external memory 1 and supplied to and stored in the prefetch buffer 34.

Conversely, if the hit or miss determination access control unit 32 determines that the type of branch is (1), (5), or (6), the second instruction sequence stored in the prefetch buffer 34 is not transferred to the instruction cache data memory 31. The 11th instruction sequence is supplied from the external memory 1 to the prefetch buffer 34 and overwritten. Hence, the second instruction sequence is destroyed.

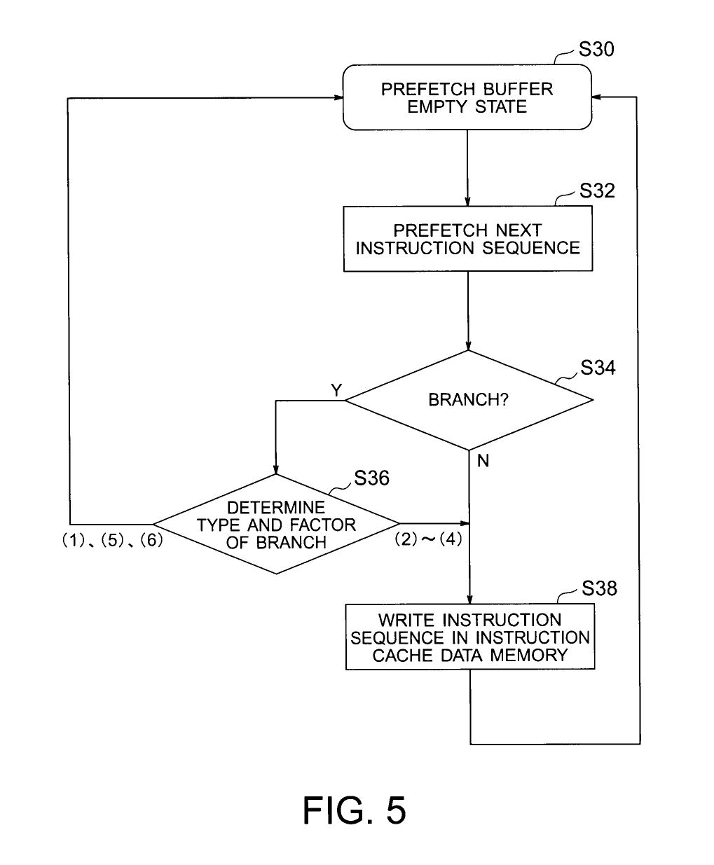

FIG. 5 is a flowchart illustrating a process of writing, in the instruction cache data memory 31, an instruction sequence perfected in the prefetch buffer 34.

In step S30, the prefetch buffer 34 is empty or stores a destructible instruction sequence.

In step S32, the hit or miss determination access control unit 32 outputs a read request signal to the external memory 1 to prefetch the target of a fetch request from the CPU 2 and, for example, the second instruction sequence next to the first instruction sequence. The readout second instruction sequence is supplied to the prefetch buffer 34. The hit or miss determination access control unit 32 supplies a write signal to the prefetch buffer 34 so that the second instruction sequence is written in it.

In step S34, the hit or miss determination access control unit 32 determines whether branch has occurred, i.e., the CPU 2 has issued fetch requests for continuous addresses. While no branch occurs, the process advances to step S38 to sequentially transfer prefetched instruction sequences to the instruction cache data memory 31 and store each instruction sequence in it.

If branch has occurred, the process advances to step S36. The hit or miss determination access control unit 32 determines the type of branch on the basis of branch information. If the type of branch is (1), (5), or (6), the probability that the prefetched instruction sequence will be executed is low. Hence, the process returns to step S30. The instruction sequence following that of the branch source is overwritten in the prefetch buffer 34. If the type of branch is one of (2) to (4), the probability that the prefetched instruction sequence will be executed is high. Hence, the process returns to step S38 to write the instruction sequence in the instruction cache data memory 31.

As described above, according to this embodiment, it is possible to prevent the process efficiency from lowering due to, e.g., prefetch of an unnecessary instruction sequence or repetitive prefetch of a necessary instruction sequence.

More specifically, when branch occurs during execution of an instruction sequence, and the next instruction sequence is already prefetched, whether to store it in the instruction cache data memory is determined on the basis of branch information by predicting the probability that the instruction sequence will be executed. This improves the process efficiency by preventing a wasteful non-executable instruction sequence from occupying an area in the instruction cache data memory 31 or suppressing a wasteful process of temporarily discarding an executable instruction sequence and prefetching it again.

The above-described embodiment is merely an example. The present invention is not limited by this, and various changes and modifications can be made within the technical scope of the present invention. For example, (1) to (6) have been exemplified as the kinds of branch in the above embodiment. However, the kinds of branch are not limited to (1) to (6).

Regarding (1) to (6), even when branch of one of (2) to (4) has occurred, the instruction sequence prefetched in the prefetch buffer need not always be transferred to and written in the instruction cache data memory. Even when branch of (1), (5), or (6) has occurred, the instruction sequence need not always be inhibited from being transferred to and written in the instruction cache data memory.

It is only necessary to determine in accordance with the execution probability of the instruction sequence following that of the branch source or branch destination whether to write the instruction sequence in the instruction cache data memory.

What is claimed is:

1. An instruction cache prefetch control apparatus comprising:
an external memory which receives and stores an instruction sequence;
a central processing unit (to be referred to as a CPU hereinafter) which receives and executes the instruction sequence; and
an instruction cache unit which reads out, from said external memory, the instruction sequence to be executed by said CPU, stores the instruction sequence, and supplies the instruction sequence to said CPU,
said instruction cache unit comprising:
an instruction cache data memory which receives and stores the instruction sequence;
a prefetch buffer which prefetches and stores an instruction sequence next to the instruction sequence as a target of a fetch request from said CPU when the next instruction sequence is not stored in said instruction cache data memory;
an instruction cache write control unit which selectively outputs, to said instruction cache data memory, one of the instruction sequence output from said external memory and the instruction sequence stored in said prefetch buffer; and
a hit or miss determination access control unit which, upon receiving, from said CPU, a fetch request for the instruction sequence stored in said prefetch buffer, transfers the instruction sequence from said prefetch buffer to said instruction cache data memory and stores the instruction sequence in the instruction cache data memory, and if branch has occurred before said CPU executes the instruction sequence stored in said prefetch buffer, determines and controls in accordance with a type of the branch whether to transfer the instruction sequence from said prefetch buffer to said instruction cache data memory and store the instruction sequence in the instruction cache data memory.

2. An apparatus according to claim 1, wherein said instruction cache unit further comprises an instruction cache tag memory which stores tag contents representing information for judging whether an instruction sequence corresponding to an address as the target of the fetch request issued from said CPU exists in said instruction cache data memory.

3. An apparatus according to claim 1, wherein said hit or miss determination access control unit determines and controls whether to transfer the instruction sequence from said prefetch buffer to said instruction cache data memory and store the instruction sequence in the instruction cache data memory in accordance with the type of the branch which indicates that
(1) if a predetermined condition is satisfied, forward branch occurs, and if the condition is not satisfied, a succeeding instruction sequence is executed without branch,
(2) backward branch occurs to form a loop,
(3) subroutine call by function call or branch to a specific instruction sequence occurs,
(4) branch by exception occurs,
(5) a subroutine is read out, or a predetermined instruction sequence is processed by exception, and a process returns, or
(6) branch to an instruction sequence which is not present in an area of said instruction cache data memory but is stored in said external memory occurs.

4. An apparatus according to claim 3, wherein said hit or miss determination access control unit does not transfer the instruction sequence from said prefetch buffer to said instruction cache data memory when the type of the branch indicates that
(1) if a predetermined condition is satisfied, forward branch occurs, and if the condition is not satisfied, a succeeding instruction sequence is executed without branch,
(5) a subroutine is read out, or a predetermined instruction sequence is processed by exception, and a process returns, or
(6) branch to an instruction sequence which is not present in an area of said instruction cache data memory but is stored in said external memory occurs, and
said hit or miss determination access control unit transfers the instruction sequence from said prefetch buffer to said instruction cache data memory and stores the instruction sequence in the instruction cache data memory when the branch indicates that
(2) backward branch occurs to form a loop,
(3) subroutine call by function call or branch to a specific instruction sequence occurs, or
(4) branch by exception occurs.

5. An apparatus according to claim 2, wherein said hit or miss determination access control unit determines and controls whether to transfer the instruction sequence from said prefetch buffer to said instruction cache data memory and store the instruction sequence in the instruction cache data memory in accordance with the type of the branch which indicates that
(1) if a predetermined condition is satisfied, forward branch occurs, and if the condition is not satisfied, a succeeding instruction sequence is executed without branch,
(2) backward branch occurs to form a loop,
(3) subroutine call by function call or branch to a specific instruction sequence occurs,
(4) branch by exception occurs,
(5) a subroutine is read out, or a predetermined instruction sequence is processed by exception, and a process returns, or
(6) branch to an instruction sequence which is not present in an area of said instruction cache data memory but is stored in said external memory occurs.

6. An apparatus according to claim 5, wherein said hit or miss determination access control unit does not transfer the instruction sequence from said prefetch buffer to said instruction cache data memory when the type of the branch indicates that
(1) if a predetermined condition is satisfied, forward branch occurs, and if the condition is not satisfied, a succeeding instruction sequence is executed without branch,
(5) a subroutine is read out, or a predetermined instruction sequence is processed by exception, and a process returns, or
(6) branch to an instruction sequence which is not present in an area of said instruction cache data memory but is stored in said external memory occurs, and
said hit or miss determination access control unit transfers the instruction sequence from said prefetch buffer to said instruction cache data memory and stores the instruction sequence in the instruction cache data memory when the branch indicates that
(2) backward branch occurs to form a loop,
(3) subroutine call by function call or branch to a specific instruction sequence occurs, or
(4) branch by exception occurs.

7. An instruction cache prefetch control apparatus comprising:
an external memory which receives and stores an instruction sequence;
a central processing unit (to be referred to as a CPU hereinafter) which receives and executes the instruction sequence; and
an instruction cache unit which reads out, from said external memory, the instruction sequence to be executed by said CPU, stores the instruction sequence, and supplies the instruction sequence to said CPU,
said instruction cache unit comprising:
an instruction cache data memory which receives and stores the instruction sequence;
a prefetch buffer which prefetches and stores an instruction sequence next to the instruction sequence as a target of a fetch request from said CPU when the next instruction sequence is not stored in said instruction cache data memory;
an instruction cache write control unit which selectively outputs, to said instruction cache data memory, one of the instruction sequence output from said external memory and the instruction sequence stored in said prefetch buffer; and
a hit or miss determination access control unit which, upon receiving a fetch request for a first instruction sequence from said CPU and determining that the first instruction sequence does not exist in said instruction cache data memory, reads out the first instruction sequence from said external memory and stores the first instruction sequence in said instruction cache data memory, upon determining that a second instruction sequence next to the first instruction sequence is stored in neither said instruction cache data memory nor said prefetch buffer, reads out the second instruction sequence from said external memory and stores the second instruction sequence in said prefetch buffer, and if branch has occurred before said CPU executes a third instruction sequence stored in said prefetch buffer, determines and controls in accordance with a type of the branch whether to transfer the third instruction sequence from said prefetch buffer to said instruction cache data memory and store the third instruction sequence in the instruction cache data memory.

8. An apparatus according to claim 7, wherein said instruction cache unit further comprises an instruction cache tag memory which stores tag contents representing information for judging whether an instruction sequence corresponding to an address as the target of the fetch request issued from said CPU exists in said instruction cache data memory.

9. An apparatus according to claim 7, wherein said hit or miss determination access control unit determines and controls whether to transfer the instruction sequence from said prefetch buffer to said instruction cache data memory and store the instruction sequence in the instruction cache data memory in accordance with the type of the branch which indicates that
(1) if a predetermined condition is satisfied, forward branch occurs, and if the condition is not satisfied, a succeeding instruction sequence is executed without branch,
(2) backward branch occurs to form a loop,
(3) subroutine call by function call or branch to a specific instruction sequence occurs,
(4) branch by exception occurs,
(5) a subroutine is read out, or a predetermined instruction sequence is processed by exception, and a process returns, or
(6) branch to an instruction sequence which is not present in an area of said instruction cache data memory but is stored in said external memory occurs.

10. An apparatus according to claim 9, wherein said hit or miss determination access control unit does not transfer the instruction sequence from said prefetch buffer to said instruction cache data memory when the type of the branch indicates that
(1) if a predetermined condition is satisfied, forward branch occurs, and if the condition is not satisfied, a succeeding instruction sequence is executed without branch,
(5) a subroutine is read out, or a predetermined instruction sequence is processed by exception, and a process returns, or
(6) branch to an instruction sequence which is not present in an area of said instruction cache data memory but is stored in said external memory occurs, and
said hit or miss determination access control unit transfers the instruction sequence from said prefetch buffer to said instruction cache data memory and stores the instruction sequence in the instruction cache data memory when the branch indicates that
(2) backward branch occurs to form a loop,
(3) subroutine call by function call or branch to a specific instruction sequence occurs, or
(4) branch by exception occurs.

11. An apparatus according to claim 8, wherein said hit or miss determination access control unit determines and controls whether to transfer the instruction sequence from said prefetch buffer to said instruction cache data memory and store the instruction sequence in the instruction cache data memory in accordance with the type of the branch which indicates that
(1) if a predetermined condition is satisfied, forward branch occurs, and if the condition is not satisfied, a succeeding instruction sequence is executed without branch,
(2) backward branch occurs to form a loop,
(3) subroutine call by function call or branch to a specific instruction sequence occurs,
(4) branch by exception occurs,
(5) a subroutine is read out, or a predetermined instruction sequence is processed by exception, and a process returns, or
(6) branch to an instruction sequence which is not present in an area of said instruction cache data memory but is stored in said external memory occurs.

12. An apparatus according to claim 11, wherein said hit or miss determination access control unit does not transfer the instruction sequence from said prefetch buffer to said instruction cache data memory when the type of the branch indicates that
(1) if a predetermined condition is satisfied, forward branch occurs, and if the condition is not satisfied, a succeeding instruction sequence is executed without branch,
(5) a subroutine is read out, or a predetermined instruction sequence is processed by exception, and a process returns, or
(6) branch to an instruction sequence which is not present in an area of said instruction cache data memory but is stored in said external memory occurs, and
said hit or miss determination access control unit transfers the instruction sequence from said prefetch buffer to said instruction cache data memory and stores the instruction sequence in the instruction cache data memory when the branch indicates that
(2) backward branch occurs to form a loop,
(3) subroutine call by function call or branch to a specific instruction sequence occurs, or
(4) branch by exception occurs.

13. A control method of an instruction cache prefetch control apparatus including an external memory which receives and stores an instruction sequence, a central processing unit (to be referred to as a CPU hereinafter) which receives and executes the instruction sequence, and an instruction cache unit which reads out, from the external memory, the instruction sequence to be executed by the CPU, stores the instruction sequence, and supplies the instruction sequence to the CPU, comprising causing the instruction cache unit to
when a fetch request for a first instruction sequence is issued from the CPU, and a hit or miss determination access control unit determines that the first instruction sequence does not exist in an instruction cache data memory, read out the first instruction sequence from the external memory and store the first instruction sequence in the instruction cache data memory,
when the hit or miss determination access control unit determines that a second instruction sequence next to the first instruction sequence is stored in neither the instruction cache data memory nor a prefetch buffer, read out the second instruction sequence from the external memory and store the second instruction sequence in the prefetch buffer, and
if branch has occurred before the CPU executes a third instruction sequence stored in the prefetch buffer, cause the hit or miss determination access control unit to determine and control in accordance with a type of the branch whether to transfer the third instruction sequence from the prefetch buffer to the instruction cache data memory and store the third instruction sequence in the instruction cache data memory.

14. A method according to claim 13, wherein the instruction cache unit further comprises an instruction cache tag memory which stores tag contents representing information for judging whether an instruction sequence corresponding to an address as the target of the fetch request issued from the CPU exists in the instruction cache data memory, and
the method further comprises causing the instruction cache unit to, upon receiving the fetch request for the first instruction sequence from the CPU, cause the hit or miss determination access control unit to supply the address as the target of the fetch request to the instruction cache tag memory, read out the tag contents, and determine whether the first instruction sequence is stored in accordance with the tag contents, thereby determining whether the first instruction sequence exists in the instruction cache data memory.

15. A method according to claim 13, wherein said hit or miss determination access control unit determines and controls whether to transfer the instruction sequence from said prefetch buffer to said instruction cache data memory and store the instruction sequence in the instruction cache data memory in accordance with the type of the branch which indicates that
(1) if a predetermined condition is satisfied, forward branch occurs, and if the condition is not satisfied, a succeeding instruction sequence is executed without branch,
(2) backward branch occurs to form a loop,
(3) subroutine call by function call or branch to a specific instruction sequence occurs,
(4) branch by exception occurs,
(5) a subroutine is read out, or a predetermined instruction sequence is processed by exception, and a process returns, or
(6) branch to an instruction sequence which is not present in an area of said instruction cache data memory but is stored in said external memory occurs.

16. A method according to claim 15, wherein said hit or miss determination access control unit does not transfer the instruction sequence from said prefetch buffer to said instruction cache data memory when the type of the branch indicates that
(1) if a predetermined condition is satisfied, forward branch occurs, and if the condition is not satisfied, a succeeding instruction sequence is executed without branch,
(5) a subroutine is read out, or a predetermined instruction sequence is processed by exception, and a process returns, or
(6) branch to an instruction sequence which is not present in an area of said instruction cache data memory but is stored in said external memory occurs, and
said hit or miss determination access control unit transfers the instruction sequence from said prefetch buffer to said instruction cache data memory and stores the instruction sequence in the instruction cache data memory when the branch indicates that
(2) backward branch occurs to form a loop,
(3) subroutine call by function call or branch to a specific instruction sequence occurs, or
(4) branch by exception occurs.

17. A method according to claim 14, wherein said hit or miss determination access control unit determines and controls whether to transfer the instruction sequence from said prefetch buffer to said instruction cache data memory and store the instruction sequence in the instruction cache data memory in accordance with the type of the branch which indicates that
(1) if a predetermined condition is satisfied, forward branch occurs, and if the condition is not satisfied, a succeeding instruction sequence is executed without branch,
(2) backward branch occurs to form a loop,
(3) subroutine call by function call or branch to a specific instruction sequence occurs,
(4) branch by exception occurs,
(5) a subroutine is read out, or a predetermined instruction sequence is processed by exception, and a process returns, or
(6) branch to an instruction sequence which is not present in an area of said instruction cache data memory but is stored in said external memory occurs.

18. A method according to claim 17, wherein said hit or miss determination access control unit does not transfer the instruction sequence from said prefetch buffer to said instruction cache data memory when the type of the branch indicates that
(1) if a predetermined condition is satisfied, forward branch occurs, and if the condition is not satisfied, a succeeding instruction sequence is executed without branch,
(5) a subroutine is read out, or a predetermined instruction sequence is processed by exception, and a process returns, or
(6) branch to an instruction sequence which is not present in an area of said instruction cache data memory but is stored in said external memory occurs, and
said hit or miss determination access control unit transfers the instruction sequence from said prefetch buffer to said instruction cache data memory and stores the instruction sequence in the instruction cache data memory when the branch indicates that
(2) backward branch occurs to form a loop,
(3) subroutine call by function call or branch to a specific instruction sequence occurs, or
(4) branch by exception occurs.
